(19) United States
(12) Patent Application Publication
(10) Pub. No.: US 2022/0288816 A1
(43) Pub. Date: Sep. 15, 2022

(54) METHOD AND APPARATUS FOR PRODUCING AN ELASTICALLY DEFORMABLE SHAPED PART AND AN ELASTICALLY DEFORMABLE SHAPED PART

(71) Applicant: FIT AG, Lupburg (DE)

(72) Inventors: Carl Fruth, Lupburg (DE); Alexander Bonke, Parsberg (DE)

(21) Appl. No.: 17/691,323

(22) Filed: Mar. 10, 2022

(30) Foreign Application Priority Data
Mar. 10, 2021 (DE) 10 2021 105 844.9

(51) Int. Cl. B29C 33/44; B29C 39/36; B29C 45/44

(52) U.S. Cl. CPC B29C 33/448; B29C 39/36; B29C 45/4457

(57) ABSTRACT

A method produces an elastically deformable molded part having a number of undercut molded-part regions, by use of a mold. To provide a technique which makes it possible to produce individual molded parts which are elastically deformable and have undercut regions from soft materials in a precise and cost-effective manner, a method is performed in which a molded-part material is introduced into the mold. The mold has a shaping contour with a number of special contour regions, which are configured for shaping the number of undercut molded-part regions of the molded part, and in which the molded part is removed from the mold by at least partially deforming the mold together with the molded part therein in such a way that the molded part elastically deforms and the mold at least partially, but in any event to the extent of the special contour regions, breaks up.

### CROSS-REFERENCE TO RELATED APPLICATION

This application claims the priority, under 35 U.S.C. § 119, of German Patent Application DE 10 2021 105 844.9, filed Mar. 10, 2021; the prior application is herewith incorporated by reference in its entirety.

### FIELD AND BACKGROUND OF THE INVENTION

The invention relates to a method for producing an elastically deformable molded part, having a number of undercut molded-part regions, by means of a mold. Moreover, the invention relates to an apparatus for carrying out the method.

An injection molding method is often used for the cost-effective production of identical molded parts in large numbers. In injection molding, the injection molding material is liquefied and injected under pressure into an injection mold. The material then cools down in the injection mold. The resulting molded part can then be removed from the injection mold. The cavity of the mold determines the configuration of the molded part in this respect.

On account of the increasing customer demand for individually configured products which are cut precisely to the specific desired size, individual and nonstandard manufacturing procedures are gaining in importance in production.

Up until now, it was still the case that no method was known by means of which it was possible to cost effectively produce components in small numbers, in particular in the form of an individual manufacturing procedure (batch size 1). The production costs for injection molded components produced by means of individually manufactured molds that can be used only once (single-use molds) are very high. The use of injection molding technology is therefore generally inefficient in such cases. In that case, a switch is made to alternative production methods, and therefore the special advantages of injection molding, in particular the high precision that can be achieved, are not utilized.

Layer building methods are used as alternative production methods. In additive manufacturing methods of this type, layers of a build material are applied one on top of the other in succession. Before the next layer in each case is applied, those locations in the respective layers that correspond to the cross section of the component to be manufactured are selectively solidified. An advantage of additive manufacturing is that components with very complex geometries can be built up without problems. This relates in particular to components with regions which are undercut to a great extent, in the case of which it would not be possible to demold the undercut from a fixed shaping contour without destroying the molded part.

However, a regular disadvantage of the use of additive manufacturing techniques is that especially soft materials cannot be processed, because the additive manufacturing technology means that a material layer always first of all has to solidify sufficiently before a new material layer is built up thereon. Therefore, the processing of various plastics materials, such as elastomers, polyurethane foams, silicone and the like, is not possible or is only possible with limitations, and therefore in particular such molded parts, which should be elastically deformable, are often not producible or are producible only with very high outlay by means of additive manufacturing.

### SUMMARY OF THE INVENTION

It is an object of the present invention to provide a technique which makes it possible to produce individual molded parts which are elastically deformable and have undercut regions from very soft materials in a highly precise and cost-effective manner.

This object is achieved by a method as claimed in the independent method claim and by an apparatus as claimed in the independent apparatus claim. Advantageous embodiments of the invention are specified in the dependent claims. The advantages and configurations explained below in conjunction with the method according to the invention apply analogously also to the apparatus according to the invention and to all other subjects of the invention, and vice versa.

The method according to the invention for producing an elastically deformable molded part, having a number of undercut molded-part regions, by use of a mold is distinguished in that molded-part material is introduced into the mold, wherein the mold has a shaping contour with a number of special contour regions, which are configured for the purpose of shaping the number of undercut molded-part regions of the molded part. The molded part is removed from the mold by at least partially deforming the mold together with the molded part therein in such a way that the molded part elastically deforms and the mold at least partially, but in any event to the extent of the special contour regions, breaks up.

The invention proposes producing an elastic molded part, in particular from a soft plastics material, in a brittle mold, from which the molded part cannot be removed forcibly, which is produced preferably by means of additive manufacturing, and which has special contour regions for the shaping of undercut molded-part regions, wherein, in order to demold the molded part, the mold is shattered. The demolding is effected exclusively by destroying at least part of the mold: no loose parts (slides or the like) are used.

In forcible demolding, plastics parts of a tough, elastic molded-part material are deformed in the elastic range when they are ejected. In the case according to the invention, although the molded parts produced are elastically deformable, they cannot be forcibly demolded, because the mold has a geometry which does not allow forcible demolding despite the deformability of the molded part on account of the undercut regions of the molded part that are to be molded.

The invention is based inter alia on the idea that the elastic molded part located in the mold is deformable. Although external sources are the cause of the mold breaking up, a deformability of the molded part makes it possible in the first place to deform the mold, which results in the mold breaking up. On account of its elastic deformability, the molded part located in the mold breaks up neither as a result of being deformed nor of the deformation of the mold, and is also not otherwise destroyed or damaged in a functionally limiting way, in particular not as a result of load being applied to it by the broken-up mold as a result of the deformation.

Since the molded part produced is elastically deformable, such that it can be deformed during the demolding, the method according to the invention differs significantly from known methods for producing non-elastically deformable molded parts, as are conventional e.g., for cores in founding, in particular in metal casting, and in which it is also not possible to remove the molded part with undercut regions from the mold.

The invention proposes the use of molds to produce individual molded parts and therefore a manufacturing method with a batch size of 1. Each molded part may have an individually defined geometry, but at least a molded-part portion having an individualized contour. The shape of the molded part is not subject to any limits in this case. The molded part produced by the method according to the invention has no geometric restriction. In particular, the method according to the invention makes it possible to produce molded parts which are undercut to a great extent, these being understood to mean molded parts with geometries which would not allow the undercut to be demolded from a fixed shaping contour without destroying the molded part. Correspondingly, a mold according to a particularly advantageous embodiment of the method is distinguished in that the number of special contour regions of the shaping contour of the mold are configured for the purpose of shaping the number of undercut molded-part regions of the molded part in such a way that the number of undercut molded-part regions molded in this way have a geometry such that, despite the elastic deformability of the molded part, it would not be possible to remove these molded-part regions from the mold without destroying the molded part.

The effect that, despite deformation of molded part and mold, exclusively the mold or parts thereof are destroyed, in particular break up into shards (fragments), is preferably obtained in that the mold material has a significantly lower elongation at break than the molded-part material. Expressed differently, the molded-part material has a higher elongation at break than the mold material from which the mold is composed at least in the region of the special contour regions of the shaping contour. In this way, the molded part, at least in the region of its undercut molded-part regions, is less brittle than the mold in the region of the special contour regions.

The ratio of the elongation at break of the mold material to the elastic material of the molded part (molded-part material) may be arbitrarily small. Within the context of the invention, however, this ratio is at least 1:3. In other words, the elongation at break of the molded-part material is at least three times the elongation at break of the mold material. The elongation at break of the molded-part material is preferably at least ten times, particularly preferably at least twenty times, the elongation at break of the mold material.

A (very) soft material, from which a non-brittle, elastic molded part can be produced, is preferably used as molded-part material. The use of a mold to be filled with the molded-part material makes it possible to produce very precise components from very elastic material. In this way, even material that is so soft that it cannot be additively processed may be used for the molded part.

The use of plastics materials as molded-part material, in particular the use of elastomers, polyurethane foams, silicone and the like, is particularly advantageous. It is also possible to use multi-component molded-part materials. According to one embodiment of the invention, the molded-part material has a Shore A hardness of <90.

The molded-part material is preferably introduced into the mold at ambient pressure or at a pressure of <50 bar. In this respect, molded-part material may e.g., be poured or injected into the mold to fill it.

According to one embodiment of the invention, use is made of insert parts, which are placed into the mold before the filling operation and bond with the elastic molded-part material and as a result become part of the molded part. The insert parts are preferably mounting elements or reinforcement elements, such as woven fabrics, for example. This makes it possible to expand the functionality of the molded parts. If the insert parts are mounting elements or if the insert parts comprise mounting elements, it is possible for molded parts provided for assembly with other components to subsequently be joined more easily to the other components to form a finished product. In this way, it is likewise especially easily possible to targetedly influence the underlying functional properties of the molded part to be produced.

According to one embodiment of the invention, a number of insert parts are used in order to produce a multi-component molded part. In that case, it is preferable for an insert part together with the soft, elastically deformable component of the molded part that consists of the molded-part material to form the molded part. That component of the molded part that is formed by the insert part then preferably consists of an insert-part material that has a different hardness, in particular a significantly greater hardness, than the molded-part material, and thus serves as a hard component of the molded part. Using suitable insert parts, this makes it possible to form any desired hard/soft molded parts with deformation capabilities that differ in certain portions.

According to one embodiment of the invention, the insert parts may also be special insert parts which are not placed into an already fully present mold, but rather are designed in such a way that they form the overall mold together with an already present basic body of the mold. In other words, insert parts of this type serve not only to influence properties of the molded part to be produced, since they form a permanent part of the molded part after the demolding operation, but rather at the same time form a functional constituent part of the mold. These insert parts themselves may also be fillable with molded-part material and in this way serve as a mold or part of the mold.

Since, according to the invention, the molded part is not directly additively manufactured, the selection of the molded-part material is also not limited by its suitability for an additive manufacturing method. Since the molded-part material does not have to be suitable for additive manufacturing, it is possible instead to use a proven molded-part material which is optimally suitable for the respective intended use.

The mold material used for the production of the mold used in the method according to the invention, but at least for the region of the special contour regions of the shaping contour, is preferably suitable for producing a shatterable, preferably additively producible mold and is furthermore preferably distinguished in that it is so brittle that it breaks up into individual shards as a result of deformation. Breaking up into individual shards that are not connected to one another has the advantage that these shards can be comparatively easily removed after the molded part has been removed from the mold.

The mold used in the application of the method according to the invention is completely or partially destroyed by the operation of removing the molded part from the mold, depending on whether the mold has a single-part or multi-part form.

In the case of a single-part mold, the mold cannot be used again after it has been destroyed, the destruction taking place at least to the extent of the special contour regions. For each molded part, a new mold is required. The mold is therefore a genuine single-use mold (lost mold).

In the case of a multi-part mold, the shaping contour with the special contour regions is preferably formed by a partial mold of the mold, which forms the mold together with one or more further mold constituent parts. In that case, preferably only that partial mold which has the shaping contour provided with special contour regions is destroyed, whereas it is not necessary to destroy the partial molds not provided with special contour regions. This makes it possible to reuse a respective part of the mold, whereas another part of the mold serves as a single-use mold and can be individually configured.

In one embodiment of the invention, the shaping contour of the mold may, in addition to the special contour regions, also comprise shaping regions which are designed to shape molded-part regions that do not have an undercut.

It has proven to be particularly advantageous if the mold has a thin-walled design. This not only makes it possible to reduce the amount of mold material when the mold is being produced. The time for producing the mold can also be reduced in this way, in particular when an additive manufacturing technique is being applied. At the same time, a small wall thickness of the mold assists it in breaking into pieces when it deforms, this being desired according to the invention. It is therefore particularly advantageous to configure the mold as a thin-walled shell construction, at least in the region of the shaping contour having the special contour regions. Depending on the mold material used, the wall thickness of the mold may be for example 0.5 to 1.5 mm.

In order to prevent the mold from breaking up already during the filling phase, i.e., when the mold material is being filled into the mold, in particular at an elevated filling pressure, according to one embodiment of the invention it is possible for the mold to be mechanically reinforced from the outside at least partially, but in any event to the extent of the shaping contour, during the filling operation. For this purpose, the outside of the mold may be supported by an additional supporting material, which preferably can be easily removed later. For example, the mold may be introduced into a stabilizing compound during the filling operation, e.g., into a sand foundation. A supporting construction or foundation of this type is advantageous especially in the case of thin-walled molds. It can moreover protect the mold from bursting, not just during the filling operation but also during any possible foaming phase of the molded-part material introduced into the mold.

According to one embodiment of the invention, it is advantageous if the mold is provided with a number of predetermined breaking points, at least in the region of the special contour regions of the shaping contour. This makes it possible not only to ensure that the mold breaks up into a multiplicity of shards at least in the region of the shaping contour when it deforms. Furthermore, the arrangement and the profile of the predetermined breaking points also make it possible to influence the size and the arrangement of the resulting shards. The predetermined breaking points are therefore advantageously designed in such a way that, on account of their size and position, the resulting shards can be removed readily from the undercut regions of the elastic molded part.

For simple and uncomplicated production of the mold, in particular when an additive manufacturing technique is applied, it has proven to be advantageous when the mold material used for the shaping contour having the special contour regions is identical to the mold material of the rest of the regions of the mold. In this way, the entire mold, or else in any event that partial mold of the mold that comprises the shaping contour with the special contour regions, consists of that mold material from which the special contour regions are also composed, and can be manufactured in one work step.

According to a preferred embodiment of the invention, a region of the mold that comprises the shaping contour or a partial mold of a multi-part mold that contains the shaping contour or the entire single-part mold is produced using an additive manufacturing method, but in any case at least that special contour region which serves to mold the undercut molded-part regions and is later destroyed for the purpose of removing the molded part from the mold.

The mold material used at least for the region of the special contour regions of the shaping contour is preferably a light-curing plastics material.

Use is made of UV crosslinking methods, such as digital light processing (DLP), UV LCD, stereolithography (SLA) and the like, for example, as preferred additive manufacturing methods. The application of such methods for the production of the mold is therefore advantageous inter alia because this makes it possible to create very smooth surfaces and also to form fine details, for example logos and texts.

The mold or partial mold may also have, in addition to the special contour regions, contour regions with mold contours which serve to shape regions of the elastic molded part that are not undercut to a great extent. In that case, these further mold contour regions may also be produced conventionally without using additive manufacturing methods.

It is also possible for the shaping contour with the special contour regions, irrespective of the way in which it was produced (additive or non-additive), to be combined with other partial molds and assembled to form a complete mold. In this respect, these other partial molds may also have been produced already in advance and/or by means of other methods, e.g., even by means of non-additive manufacturing, and using other mold materials. These other partial molds may advantageously have different material properties, and therefore in particular it is also possible to obtain a different deformation behavior. In this way it is easily possible to targetedly allow or prevent the breaking up of defined regions of the mold.

According to one embodiment of the invention, a multi-part mold may also be produced in that the mold is formed at least partially by special insert parts, which partially form the mold or form a constituent part of the mold, as described above.

The demolding takes place after the soft molded-part material in the mold has solidified, as a result of which the desired molded part is produced. The demolding is effected by deforming the mold and the molded part therein. On account of this deformation, the shaping contour of the brittle mold, at least in the region of the special contour regions, is destroyed by mechanical breaking up or shattering. When the fracture strength of the mold material is exceeded, this preferably leads to separation fractures or brittle fractures. The mold may also be broken up, however, as a result of the occurrence of deformation fractures or ductile fractures.

According to the invention, the mold is deformed. The molded part still located in the mold is also deformed together with the mold. Advantageously, the mold is deformed by applying pressure to the mold from the outside. The pressure can be applied to the outside of the mold either directly by mechanical application of a medium or else indirectly by pneumatic or hydraulic application of a medium. If a support structure or foundation is used, the pressure is applied preferably while the mold is still mechanically reinforced from the outside.

For shattering the shaping contour, it has proven particularly advantageous to squeeze the mold together with the molded part therein between rollers or in a vice. The apparatus for carrying out the method according to the invention comprises suitable pressurization means for this purpose.

By breaking up the mold at least to the extent of the special contour regions of the shaping contour, it is possible for all of the shards (fragments) of the shaping contour to be removed from the undercut regions of the molded part. Depending on the geometry of the elastic molded part, this may take place directly during the breaking-up operation or else in a subsequent step.

The removal of the fragments may advantageously be assisted by vibration, agitation, rotation, or by purging with air or liquid.

In one embodiment of the invention, in which not only shatterable but also soluble mold material is used, the fragments may be dissolved after the mold is destroyed. In that case, the removal of small and extremely small fragments, which is complex under some circumstances, is dispensed with. For this purpose, mold material is selected such that it can dissolve in a solvent.

For reasons of environmental protection, however, the fragments are preferably removed purely mechanically. In this way, the fragments can be disposed of easily and favorably or at least partially recycled to form mold material.

According to an advantageous embodiment of the invention, the mold is provided with a suitable release agent before it is filled. This makes it possible to have the effect that the fragments of the mold can be detached from the elastic molded part in good time. In that case, the fragments are no longer supported by the molded part and can be more easily broken up into smaller shards. Depending on the materials used, it is possible to use a silicone-containing agent as release agent, for example. If a release agent is used, the removal of the molded part from the mold or the removal of the fragments is preferably followed by a cleaning step, in which the resulting elastic molded part has the rest of the release agent cleaned from it by means of a suitable solvent.

According to a further advantageous embodiment of the invention, it is provided to embrittle the mold in a suitable manner before it is filled with the molded-part material or alternatively before the demolding operation. For this purpose, it is possible for example to carry out intensive irradiation with UV light or the mold may be subjected to intense drying. The mold may also be exposed to an atmosphere that chemically embrittles the mold material.

The invention provides a technique that makes it possible to highly precisely produce individual, elastically deformable molded parts having undercut regions from very soft materials in an easy and comparatively cost-effective way.

The invention contains not only the described method for producing an elastically deformable molded part, having a number of undercut molded-part regions, by means of a mold. The invention similarly contains an apparatus configured for the purpose of carrying out this method. This apparatus contains all of the means and devices configured to carry out the method steps described.

The invention also contains the individual elastic molded part produced by a method of this type. Therefore, the invention similarly also relates to the use of an elastically deformable molded part produced by the method according to the invention as part of an object or any object that comprises an elastically deformable molded part produced by this method. A molded part produced by the method according to the invention can advantageously be used for the purpose of individualizing an object, in particular in orthopedic technology or for the production of individual products for improving performance, e.g., tools or sports equipment. Such a molded part according to the invention may be used in particular as part of a shoe, in particular as a shoe sole or as part of a shoe sole.

The invention likewise contains a method for producing a mold or partial mold which is described in conjunction with the method according to the invention, which can be used with this method, and which has a shaping contour, in particular by means of additive manufacturing, and the use of such a mold or partial mold for the method according to the invention. The invention also contains a material suitable for use as a mold material for producing the shaping contour of the mold or partial mold, and the use of such a material for producing a shatterable, in particular additively produced, shaping contour of a mold or partial mold for use in the method according to the invention.

Other features which are considered as characteristic for the invention are set forth in the appended claims.

Although the invention is illustrated and described herein as embodied in a method for producing an elastically molded part, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, sectional view of an empty mold;

FIG. 2 is a diagrammatic, sectional view of the mold filled with molded-part material;

FIG. 3 is a diagrammatic, sectional view of a partially broken-up mold; and

FIG. 4 is a diagrammatic, sectional view of a molded part.

### DETAILED DESCRIPTION OF THE INVENTION

All of the figures show the invention as not true to scale and show it merely schematically and only with its essential constituent parts. In the figures, the same reference signs correspond to elements with identical or comparable functions.

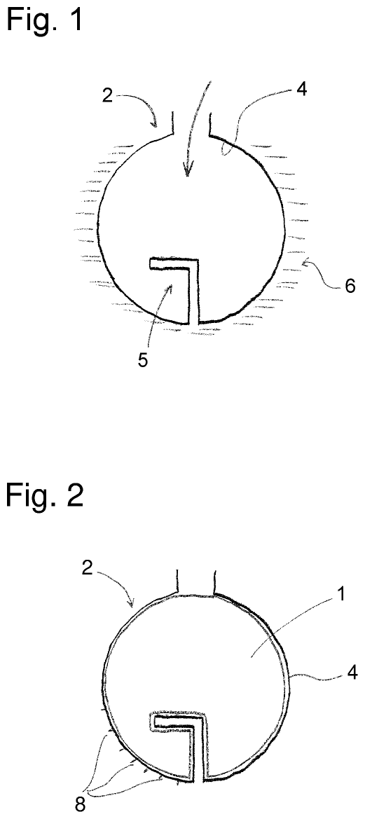

Referring now to the figures of the drawings in detail and first, particularly to FIGS. 1 and 4 thereof, there is shown an elastically deformable molded part 1 that is produced by means of a mold 2 by the method described. The finished molded part 1 has a number of molded-part regions 3 that are undercut to a great extent, see FIG. 4.

The mold 2 contains a fixed, i.e., not elastically deformable, shaping contour 4 with a number of special contour regions 5, as is illustrated in FIG. 1. The special contour regions 5 are configured for the purpose of shaping the number of undercut molded-part regions 3 of the molded part 1. The thin-walled mold 2 is manufactured from a brittle, shatterable material, at least to the extent of the special contour regions 5. The mold 2 is produced by means of additive manufacturing. The mold material is a light-curing plastics material.

First, molded-part material is introduced into the mold, as is indicated in FIG. 1 by the arrow. The mold 2 is filled at ambient pressure or at low pressure. Nonetheless, the mold 2 is mechanically reinforced from the outside by virtue of a sand foundation 6 which is indicated in FIG. 1. The molded-part material is a comparatively soft plastics material, for example PU foam. The ratio of the elongation at break of mold material to molded-part material is at least 1:3.

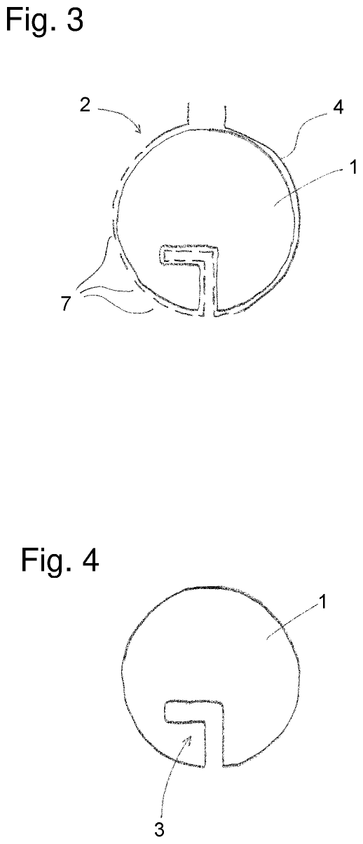

After the soft molded-part material in the mold 2 has solidified, the molded part 1 is removed from the mold 2. To this end, the mold 2 together with the molded part 1 therein is at least partially deformed in such a way that the molded part 1 elastically deforms without damage and the mold 2 at least partially, but in any case to the extent of the special contour regions 5, breaks up into shards (fragments) 7. In the region of the special contour regions 5, the shaping contour 4 of the mold 2 is provided with predetermined breaking points 8, as is indicated in FIG. 2. The partially broken-up mold 2 is depicted in FIG. 3. In order to obtain the desired deformation, pressure is applied to the mold 2 and therefore also the molded part 1 in the mold 2, the cause of which is that load is directly applied to the mold 2 by rotating rollers (not depicted). The mold 2 is broken up in the region of the special contour regions 5 as a result of the deformation of the mold 2 during the pressurization and can also take place on account of the deformation of the elastic molded part 1.

Lastly, the fragments 7 are removed, for example by simply vibrating, agitating and/or rotating the molded part 1. FIG. 4 shows the finished molded part 1.

All of the features illustrated in the description, the following claims and the drawing can be essential to the invention both individually and in any desired combination with one another.

These features and combinations of features may respectively substantiate an independent invention, and express reservation is made to the claiming thereof.

When a combination of features defining an invention is specified, it is not imperatively necessary to combine individual features from the description of an exemplary embodiment with one or more or all other features specified in the description of this exemplary embodiment; in this respect, any sub-combination of features of one or more exemplary embodiments is expressly also disclosed.

Moreover, substantive features of the apparatus may be used as method features when reworded, and method features may be used as substantive features of the apparatus when reworded. In this way, reworded features are automatically also disclosed.

The following is a summary list of reference numerals and the corresponding structure used in the above description of the invention:
1 Molded part
2 Mold
3 Undercut molded-part region
4 Shaping contour
5 Special contour region
6 Foundation
7 Shards
8 Predetermined breaking points

1. A method for producing an elastically deformable molded part having at least one undercut molded-part region, by means of a mold, which comprises the steps of:
introducing a molded-part material into the mold, the mold having a shaping contour with at least one special contour region, which is configured for a purpose of shaping the at least one undercut molded-part region of the elastically deformable molded part; and
removing the elastically deformable molded part from the mold by at least partially deforming the mold together with the elastically deformable molded part therein such that the elastically deformable molded part elastically deforms and the mold at least partially, but in any event to an extent of the at least one special contour region, breaks up.

2. The method according to claim 1, wherein the at least one special contour region is configured for a purpose of shaping the at least one undercut molded-part region such that the at least one undercut molded-part region has a geometry such that it would not be possible to remove the at least one undercut molded-part region from the mold without destroying the elastically deformable molded part.

3. The method according to claim 1, wherein the molded-part material has a higher elongation at break than a material of the mold.

4. The method according to claim 3, wherein the elongation at break of the molded-part material is at least three times an elongation at break of the material of the mold.

5. The method according to claim 1, wherein the molded-part material is a plastic material.

6. The method according to claim 5, wherein the molded-part material has a Shore A hardness of <90.

7. The method according to claim 5, which further comprises introducing the molded-part material into the mold at ambient pressure or at a pressure of <50 bar.

8. The method according to claim 1, wherein a material from which the mold is composed at least in the region of the at least one special contour region is distinguished in that it breaks up into shards as a result of deformation.

9. The method according to claim 1, wherein the mold is a multi-part design mold, and only that part of the mold that has the shaping contour with the at least one special contour region breaks up as a result of the at least partial deformation of the mold and of the elastically deformable molded part therein during a demolding operation.

10. The method according to claim 1, wherein the mold has a plurality of predetermined breaking points at least in the region of the at least one special contour region of the shaping contour.

11. The method according to claim 1, wherein the mold is produced by means of additive manufacturing at least in the region of the at least one special contour region of the shaping contour.

12. The method according to claim 11, wherein a material of the mold is a light-curing plastic material at least in the region of the at least one special contour region of the shaping contour.

13. The method according to claim 1, which further comprises destroying the shaping contour at least in the region of the at least one special contour region by mechanically breaking up in a course of deformation of the mold and the molded part therein.

14. The method according to claim 13, wherein the deforming of the mold is performed by applying pressure to the mold.

15. The method according to claim 3, wherein the elongation at break of the molded-part material is at least ten times the elongation at break of the material of the mold.

16. The method according to claim 3, wherein the elongation at break of the molded-part material is at least twenty times the elongation at break of the material of the mold.

17. The method according to claim 8, wherein the shards break into individual shards as a result of the deformation.

18. An apparatus for producing an elastically deformable molded part having at least one undercut molded-part region, the apparatus comprising:
a mold having a shaping contour with at least one special contour region, being configured for a purpose of shaping the at least one undercut molded-part region of the elastically deformable molded part;
means for introducing a molded-part material into said mold; and
means for removing the elastically deformable molded part from said mold by at least partially deforming said mold together with the elastically deformable molded part therein in such a way that the elastically deformable molded part elastically deforms and said mold at least partially, but in any event to an extent of said at least one special contour region, breaks up.

19. An object, comprising:
an elastically deformable molded part produced by the method according to claim 1.

20. The object according to claim 19, wherein the object is a shoe.
